(19) United States
(12) Patent Application Publication
(10) Pub. No.: US 2008/0186409 A1
(43) Pub. Date: Aug. 7, 2008

(54) SILICON TUNER AND A METHOD OF PROCESSING SIGNAL THEREOF

(75) Inventors: Hyun-koo KANG, Yongin-si (KR); Jae-young Ryu, Suwon-si (KR); Ju-ho Son, Suwon-si (KR); Dae-yeon Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/860,618

(22) Filed: Sep. 25, 2007

(30) Foreign Application Priority Data
Feb. 2, 2007 (KR) 2007-11080

(51) Int. Cl. H04N 5/50

(52) U.S. Cl. 348/731; 348/E05.097

(57) ABSTRACT

A silicon tuner using a sigma delta-analog digital converter (SD-ADC) includes a radio frequency (RF) signal processor to process an RF signal input from an antenna, a mixer to convert the RF signal into an intermediate frequency (IF) signal, an SD-ADC to convert an IF signal into a digital signal, and an IF signal processor to process the converted IF signal. Accordingly, a silicon tuner in which a signal processor and a size are improved is provided.

### CROSS-REFERENCE TO RELATED APPLICATIONS

This application claims priority under 35 U.S.C. § 119(a) from Korean Patent Application No. 2007-11080, filed on Feb. 2, 2007, in the Korean Intellectual Property Office, the contents of which are incorporated herein by reference in its entirety.

### BACKGROUND OF THE INVENTION

1. Field of the Invention

The present general inventive concept relates to a silicon tuner and a method of processing a signal thereof. More particularly, the present general inventive concept relates to a silicon tuner using a sigma delta-analog digital converter (SD-ADC) and a method of processing an image thereof.

2. Description of the Related Art

A conventional tuner to receive a TV signal is built in various appliances such as an analog television (ATV), a digital television (DTV), a videocassette recorder (VCR), a set top box (STB), and a digital video recorder (DVR). A Can type tuner is most generally used, as its price is cheap.

However, in the transition phase to a digital broadcast, broadcast providers provide both an analog signal and a digital signal to adjacent channels. In this case, a tuner having an excellent selectivity is required to effectively control signal interference between the adjacent channels.

Channels between active channels are used as a protective band to complement a low tuner having a low selectivity of conventional analog broadcast, but it is not approved in a digital broadcast. The conventional Can type tuner having a low selectivity does not meet conditions for a digital broadcast. Meanwhile, a silicon tuner appears as a new technology of tuner.

A silicon tuner does not require mechanical tuning, calibration, or adjustment, and is considered as an excellent solution to receive a high quality digital and analog signal by processing interference and noise related to a TV signal transmission.

However, the silicon tuner does not provide performance as good as a conventional Can type tuner. That is, a 12 bit analog-digital converter (ADC) is used to convert an IF signal into a digital signal such that power consumption (about 1 W) is considerably high, and die-size is increased due to the requirement for two ADCs for I and Q signals. There are also the problems that adjacent-channel interference is not effectively removed, and an up/down circuit diagram is complicated.

### SUMMARY OF THE INVENTION

The present general inventive concept provides a silicon tuner and a method of processing a signal thereof to reduce power consumption and power size, and to improve a process of processing a signal by using a sigma delta-analog digital converter (SD-ADC) and by processing an intermediate frequency (IF) by digital.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a silicon tuner, including a radio frequency (RF) signal processor to process an RF signal input from an antenna, a mixer to convert the RF signal into an IF signal, an SD-ADC to convert an IF signal into a digital signal, and an IF signal processor to process the converted IF signal.

The silicon tuner may further include a detector to detect signals of input and output ports of the IF signal processor.

The silicon tuner may further include an IF automatic gain controller to control intensity of a signal which is input to the SD-ADC according to the signal detected by the detector.

The RF signal processor may include an RF controller to control intensity of the RF signal input from the antenna according to the signal detected by the detector, and an RF bandpass filter to filter the controlled RF signal.

The IF signal processor may include a channel selector to select a channel of the IF signal, an image remover to remove an image frequency component of the IF signal, and a channel filter to remove an inter-channel interference of the IF signal.

The silicon tuner may further include a digital converter to increase a frequency of the converted IF signal which passes through the IF signal processor, an A/D converter to convert the IF signal into an analog signal, and an analog output unit to output the analog IF signal which passes through the A/D converter.

The silicon tuner may further include a digital output unit to output the digitized IF signal passing the IF signal processor.

The silicon tuner may further include a filter to remove harmonic component of the IF signal which passes through the mixer, and a signal component of an adjacent channel.

The foregoing and/or other aspects and utilities of the present general inventive concept may be achieved by providing a method of processing a signal, the method including processing an RF signal input through an antenna, converting the RF signal into an IF signal, digitizing the IF signal by using SD-ADC and processing the digitized IF signal.

The method may further include detecting an intensity of the IF signal passing the SD-ADC and intensity of the digitized IF signal.

The method may further include controlling an intensity of an analog IF signal inputted to the SD-ADC by using the intensity of the IF signal passing the detected SD-ADC and the intensity of the digitized IF signal.

The processing of the RF signal input through the antenna may include controlling an intensity of an RF signal by using the intensity of the IF signal passing the detected SD-ADC and the intensity of the digitized IF signal, and filtering the controlled RF signal in an RF band.

The processing of the digitized IF signal may further include selecting a channel of the digitized IF signal, removing an image frequency included in the digitized IF signal, and removing an inter-channel interference of the digitized IF signal.

The method may further include increasing the digitized IF signal, converting the increased digitized IF signal into an analog signal, and outputting the analog IF signal.

The method may further include outputting the digitized IF signal.

The method may further include removing a harmonic component of the IF signal, and a signal component of an adjacent channel.

The foregoing and/or other aspects and utilities of the present general inventive concept may be achieved by providing a computer readable recording medium having embodied thereon a computer program to execute a method, wherein the method includes processing an RF signal input through an antenna, converting the RF signal into an IF signal, digitizing the IF signal by using SD-ADC, and processing the digitized IF signal.

The foregoing and/or other aspects and utilities of the present general inventive concept may be achieved by providing a silicon tuner, including a sigma delta-analog digital converter (SD-ADC) to convert an IF signal into a digital signal, and an IF signal processor to process the converted IF signal, wherein the converted IF signal is output if the converted IF signal is digitized or the converted IF signal is converted to an analog signal and then output.

The silicon tuner may further include a digital converter to increase a frequency of the converted IF signal which passes through the IF signal processor, an A/D converter to convert the IF signal into an analog signal, and an analog output unit to output the analog IF signal which passes through the A/D converter.

The silicon tuner may further include a digital output unit to output the digitized IF signal passing the IF signal processor.

The foregoing and/or other aspects and utilities of the present general inventive concept may be achieved by providing a method of processing a signal, including converting an IF signal into a digital signal, and processing the converted IF signal, wherein the converted IF signal is output if the converted IF signal is digitized or the converted IF signal is converted to an analog signal and then output.

The foregoing and/or other aspects and utilities of the present general inventive concept may be achieved by providing a computer readable recording medium having embodied thereon a computer program to execute a method, wherein the method includes converting an IF signal into a digital signal, and processing the converted IF signal, wherein the converted IF signal is output if the converted IF signal is digitized or the converted IF signal is converted to an analog signal and then output.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a silicon tuner, according to an exemplary embodiment of the present general inventive concept;

FIG. 2 is a block diagram illustrating an SD-ADC of the silicon tuner of FIG. 1.

FIG. 3 is a block diagram illustrating a detailed construction of an RF signal processor of the silicon tuner of FIG. 1;

FIG. 4 is a block diagram illustrating a detailed construction of an IF signal processor of the silicon tuner of FIG. 1;

FIG. 5 is a block diagram illustrating a silicon tuner according to an exemplary embodiment of the present general inventive concept;

FIG. 6 is a flowchart illustrating a method of processing a silicon tuner according to an exemplary embodiment of the present general inventive concept;

FIG. 7 is a flowchart illustrating a method of processing a signal of a silicon tuner according to another embodiment of the present general inventive concept;

FIG. 8 is a flowchart illustrating a method of auto gain control; and

FIG. 9 is a flowchart illustrating a process of processing a digital signal of signal passing SD-ADC.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

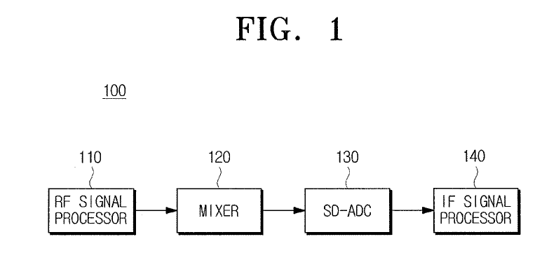

FIG. 1 is a block diagram illustrating a silicon tuner, according to an exemplary embodiment of the present general inventive concept. Referring to FIG. 1, a silicon tuner 100 may include a radio frequency (RF) signal processor 110, a mixer 120, a sigma delta-analog digital converter (SD-ADC) 130, and an intermediate frequency (IF) signal processor 140.

The silicon tuner 100 may adopt a double conversion method which uses two steps to convert incoming RF signals to lower-frequency single-channel outputs to achieve high-quality reception of DTTV channels. More specifically, the double conversion method modulates an entire RF spectrum passing through the RF filter directly to baseband where channel selection is done by low-pass signal processing. No band-pass filtering is performed at an IF. Furthermore, translation of the takes place in two steps, using two oscillators and two sets of mixers. Accordingly, no oscillator operates at an RF input frequency, and tuning of a receiver can be accomplished using a low-frequency LO (local oscillator). Because a second LO is fixed, trade-offs may be obtained with regard to LO phase noise. Accordingly, the double conversion method reduces between fifty to one hundred parts of the silicon toner 100, whereby a size of the silicon tuner 100 is reduced, and a competitive price can result due to smaller and less expensive components. Therefore, the double-conversion method eliminates a need to include discrete tracking filters and manually aligned coils, thereby further reducing system cost and complexity, while improving performance and reliability. Hence, an adjustment point in the process of producing the system is removed to reduce fabricating time, thereby enhancing productivity. In essence, mechanical tuning, calibration, or adjustment is not required in double conversion, and interference and a noise related to transmitting TV signal is processed such that a reception of high quality digital, and analog signals is possible.

The RF signal processor 110 processes a TV signal which has RF band between 48 MHz˜860 MHz received through an antenna (ANT). Particularly, the RF signal processor 110 may process a signal using a process such as low noise amplification or RF signal filtering, and detailed descriptions thereof will be explained below.

The mixer 120 converts an RF signal into an IF signal of a center frequency 4 MHz. The mixer 120 down-converts the RF signal into the IF signal by mixing the LO signal output from an RF local oscillator (RF LO) (not illustrated). The mixer 120 mixes the RF signal input from the RF signal processor 110 with the LO signal output from the RF LO, and down-converts the mixed signal into an IF signal. The IF signal has a frequency which is converted to be decoded into super heterodyne-type reception, in which RF frequency is converted into a low frequency in stages.

The mixer 120 removes LO harmonic signal components which are generated from the LO signal of the RF LO.

The SD-ADC 130 converts the IF signal output from the mixer 120 into a digital signal. The SD-ADC 130 may be implemented as a 12 bit SD-ADC, and may convert a 4 MHz IF signal into a 12 bit digital signal.

More specifically, the SD-ADC 130 performs 1 bit a looping digital-to-analog conversion in a sampling frequency higher than a bandwidth of an input signal, so that the input signal is converted from analog to digital (AD). Output samples from the SD-ADC 130 include an input signal and a quantization noise. However, the SD-ADC 130 may be designed to insert a quantization noise into a signal bandwidth (for example, into a bandwidth where a signal exists) to produce a quantization noise out-of-frequency band in which filtering is conducted.

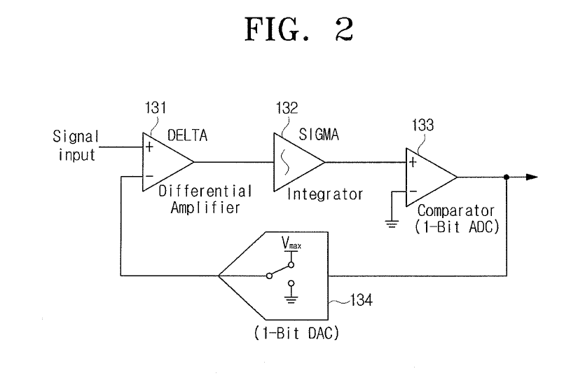

FIG. 2 is a block diagram illustrating the SD-ADC 130 of the silicon tuner 100 of FIG. 1.

The SD-ADC operates as a feedback loop which converges a differential error into zero. The feedback loop is conducted by measuring a difference between an analog input signal output from the mixer 120 and a feedback DAC signal output from an oversampling digital-to-analog converter 134. That is, a differential amplifier 131 produces an error signal that represents a difference between the analog input signal and the feedback DAC signal. An integrator 132 performs a time domain integration of the error signal produced by the differential amplifier and outputs an integrated analog output signal The integrated analog output signal is compared with a reference signal by a comparator 133 to produce a one-bit data stream, and the one-bit data stream is provided to the oversampling digital-to-analog converter 134 and the IF signal processor 140. If the error term is positive, the oversampling digital-to-analog converter 134 produces an output of a feedback DAC to be driven in a high state to reduce error terms, and if the error term is negative, the oversampling digital-to-analog converter 134 produces the output of the feedback DAC to be driven in a low state, such that an error term is reduced. Density of zeros and ones in the comparator 133 is proportional to an analog input voltage. Since the structure and principle of SD-ADC are well known by those skilled in the art, a detailed description thereof will be omitted.

The IF signal processor 140 processes a signal of intermediate frequency digitized by the SD-ADC 130. That is, a signal process including channel selection, image removing, and channel filtering is conducted. A detailed description of the above signal process will be explained below.

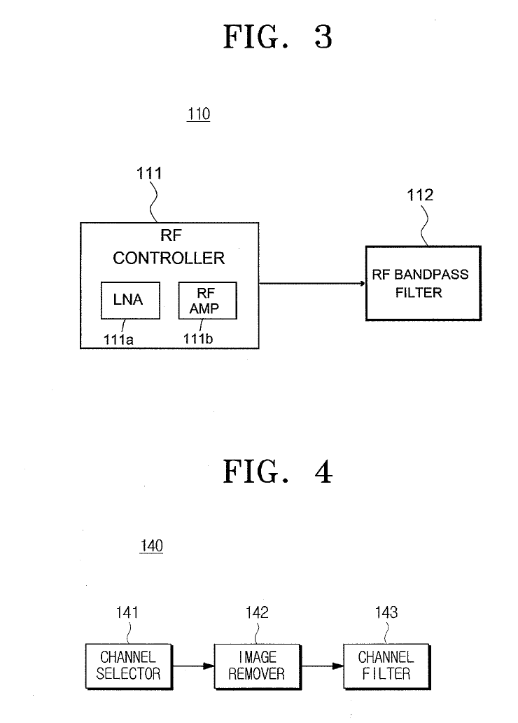

FIG. 3 is a block diagram illustrating a detailed construction of the RF signal processor 110 of the silicon tuner 100 of FIG. 1. Referring to FIG. 3, the RF signal processor 110 includes an RF controller 111 and an RF bandpass filter 112.

The RF controller 111 includes a low noise amplifier (LNA 111a) and an RF amplifier 111b.

The LNA 111a receives an RF signal input through an antenna, conducts a low noise amplification of the input RF signal at a preset gain rate, and outputs the amplified RF signal to the RF amplifier. That is, the LNA 111a amplifies the signal, while refraining from amplifying the noise of the received signal.

If the RF signal which passes through the LNA 111a has a high amplitude, the RF amplifier 222b operates as an attenuator, and if the RF signal which passes through the LNA has a low amplitude, the RF amplifier 111b operates as an amplifier. The attenuator attenuates (i.e., lowers an amplitude or power of a signal without distorting its waveform) power to a desired degree by using a plurality of exhausting elements such as resistor.

The RF amplifier 111b may be implemented as a wideband amplifier. The wideband amplifier amplifies a frequency signal in wideband 48 MHz˜860 MHz including all TV signals in which distortion of the amplified signal is minimized. The RF amplifier may be a vacuum tube, or a transistor which produces a large resulting amplification by multiplying gain by bandwidth.

The RF bandpass filter 112 filters the signal input from the RF controller 111. That is, the RF bandpass filter 112 passes a band group to be used by the mixer 120, from among the signals input from the RF controller 111, and filters out band groups that are not going to be used by the mixer 120.

Particularly, the RF bandpass filter 112 may be implemented as a variable band pass filter in which a pass band is varied to include about three channels by a channel selection among the input TV signals. Only the bandpass surrounding the selected channel is passed, and the remaining signal is blocked. Accordingly, a noise source of the analog IF signal by the LO harmonic signal may be removed in advance. That is, harmonic elements of the RF signal corresponding to the LO harmonic signal band are removed.

The RF local oscillator (not illustrated) supplies a local oscillating frequency to perform frequency synthesis to the mixer 120 as well as to the RF bandpass filter 112.

A phase locked loop (PLL) (not illustrated) causes the frequency output from the RF LO not to oscillate, but to be fixed. That is, the PLL elaborately adjusts a voltage of a voltage control oscillator (VCO) used as RF LO through a control input, thereby moving the frequency output from the RF LO to the desired frequency and fixing the moved frequency.

FIG. 4 is a block diagram illustrating a detailed construction of the IF signal processor 140 of the silicon tuner of FIG. 1. Referring to FIG. 4, the IF signal processor 140 includes a channel selector 141, an image remover 142, and a channel filter 143.

The IF signal processor 140 is a digital signal processor (DSP) which processes an IF range into a digital signal, and which processes the IF signal digitized by the SD-ADC 130.

The channel selector 141 selects a desired channel signal from the signals converted into the IF signal by bandpass filtering. That is, the channel selector selectively receives an input of I signal data and Q signal data, and outputs the input data. An I signal is one of two color signals, containing reddish orange and bluish green components to which a human eye is sensitive. A Q signal is another one of the two color signal, containing yellow and violet components to which the human eye is relatively insensitive.

The image remover 142 removes an image frequency which may be generated by mixing operation of the mixer 120.

The image frequency, which is also known as picture frequency, is frequency-symmetrical to a received electric wave with reference to the LO frequency in the super heterodyne method. For example, in standard broadcasting, an IF is 455 kHz. The local oscillating frequency is added to a frequency of the desired channel signal, and a total combined frequency value is produced. The total combined frequency value is known as the image frequency. If an electric wave having the image frequency exists, the image frequency is added to the local oscillating frequency, which introduces a shift in the IF by an amount equal to the image frequency. Then upon down-shifting to baseband, the image frequency may be removed.

The channel filter 143 performs a channel filtering. The ‘channel filtering’ refers to selecting only a desired channel by attenuating interference by a channel to correctly select a channel. Accordingly, a reduced layout size of an output image corresponding to the desired channel is obtained.

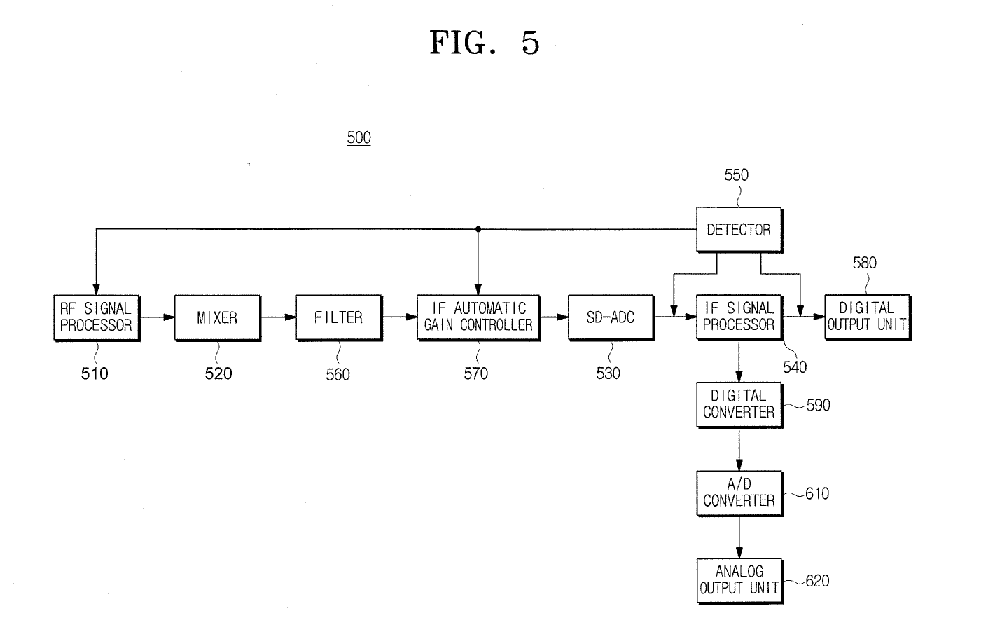

FIG. 5 is a block diagram illustrating a silicon tuner 500 according to an exemplary embodiment of the present general inventive concept. Referring to FIG. 5, the silicon tuner 500 includes an RF signal processor 510, a mixer 520, an SD-ADC 530, an IF signal processor 540, a detector 550, a filter 560, an IF automatic gain controller 570, a digital output unit 580, a digital converter 590, an analog to digital (A/D) converter 610, and an analog output unit 620. The RF signal processor 520 and the mixer illustrated in FIG. 5 are the same as the RF signal processor 310 and the mixer 320 illustrated in FIGS. 1 through 4, and thus a description thereof will be omitted.

The detector 550 detects signals of input and output ports, respectively, of the IF signal processor 540 to drive an inside automatic gain control (AGC). The detector 550 is connected to the input and output ports of the IF processor 540, and detects a level of the IF signal. The detector 550 may output a control signal which adjusts AGC gain of the RF controller 111 of FIG. 2 and the IF automatic gain controller 570 according to a size of the detected signal level.

The filter 560 removes a harmonic component of the IF signal which passes through the mixer 520, and a signal component of an adjacent or distant channel. The filter 560 may be implemented in a complex structure to reduce an I signal and/or Q signal mismatch.

The IF automatic gain controller 570 controls intensity of a signal which is input to the SD-ADC 530 according to the signal detected by the detector 550. Accordingly, the IF automatic gain controller 570 maintains a constant level of the signal input to the SD-ADC 530, and also prevents the level of the input signal from being saturated.

The digital output unit 580 outputs the digitized IF signal passing the IF signal processor 540. A 12 bit digital IF signal is output, and the output 12 bit digital IF signal may be applied to an advanced television system committee (ATSC).

The digital converter 590 increases the frequency of the IF signal which passes through the IF signal processor 540. The 12 bit digital IF signal is converted into a digital IF signal having 44 MHz.

The A/D converter 610 converts the IF signal to an analog signal. More specifically, the digital IF signal having 44 MHz is converted into an analog signal having 44 MHz.

The analog output unit 620 outputs the analog IF signal which passes through the A/D converter. The output analog signal may be applied to a national television system committee (NTSC).

An IF RF LO (not illustrated) supports a local oscillating frequency to perform frequency synthesis to the A/D converter 610 as well as to the SD-ADC 530.

The PLL (not illustrated) causes the frequency output from the IF LO to not oscillate, but to be fixed. That is, the PLL elaborately adjusts a voltage of a voltage control oscillator (VCO) used as IF LO through a control input, such that the frequency output from the IF LO is moved to the desired frequency, and the moved frequency is fixed.

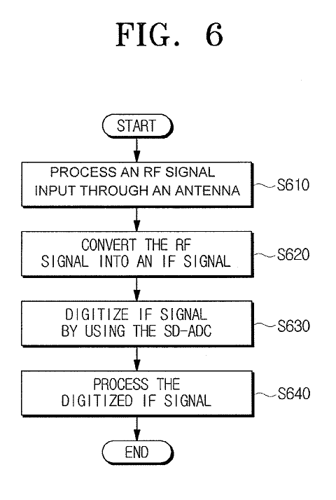

FIG. 6 is a flowchart illustrating a method of processing a silicon tuner according to an exemplary embodiment of the present general inventive concept. Referring to FIG. 6, in operation S610, if an RF signal input through an antenna is processed, in operation S620, the processed RF signal is converted into an IF signal. In operation S630, the converted IF signal is digitized by using the SD-ADC, and in operation S640, the digitized IF signal is processed.

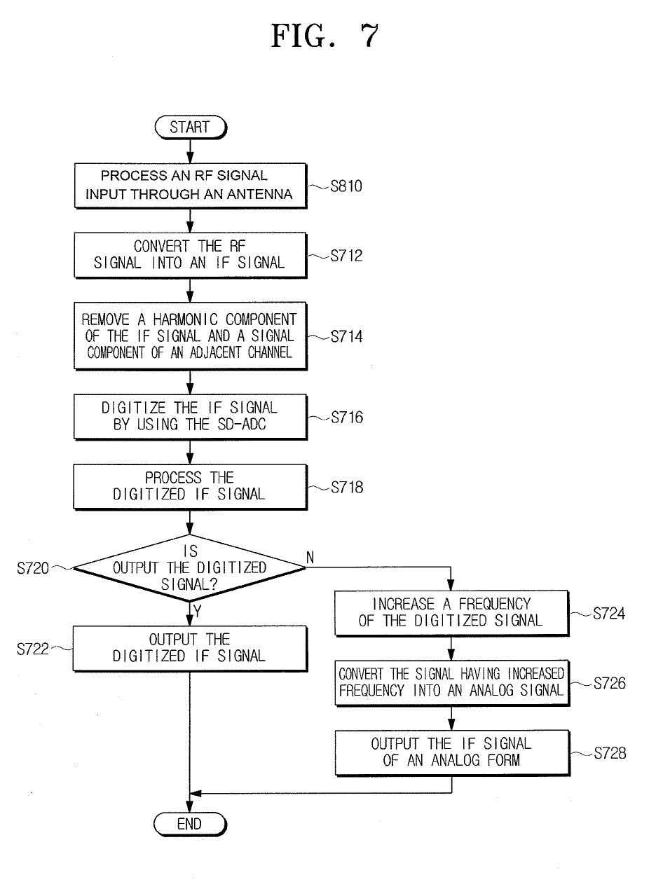

FIG. 7 is a flowchart illustrating a method of processing a signal of a silicon tuner according to another exemplary embodiment of the present general inventive concept. Referring to FIG. 7, in operation S710, if an RF signal input through an antenna is processed, in operation S712, the processed RF signal is converted into an IF signal. In operation S714, a harmonic component of the converted IF signal and a signal component of an adjacent channel signal are removed. In operation S716, the IF signal, from which the harmonic component and the adjacent channel signal component are removed, is digitized by using the SD-ADC, and in operation S718, the digitized IF signal is processed.

In operation S720-Y, if the digitized IF signal is output, the processed digital IF signal is output in operation S722.

In operation S720-N, if an analog signal is output, in operation S724, a frequency of the digitized IF signal is increased, and in operation S726, the digitized IF signal having increased frequency is converted by using the DAC into an analog signal. In operation S728, the signal of an analog form is output.

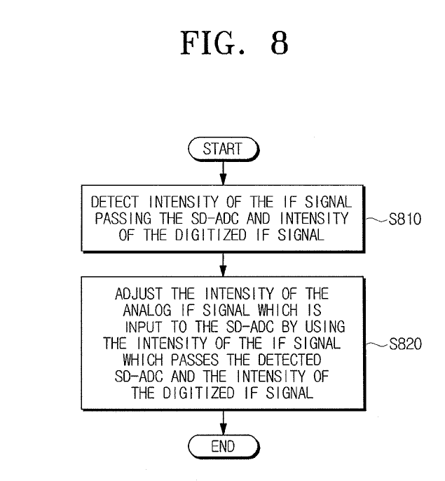

FIG. 8 is a flowchart illustrating a method of an auto gain control.

Referring to FIG. 8, on operation S810, after intensity of the IF signal output from the SD-ADC and intensity of the digitized IF signal are detected, in operation S820, the intensity of the signal which is input to the SD-ADC is adjusted by using the intensity of the IF signal which passes the detected SD-ADC and the intensity of the digitized IF signal.

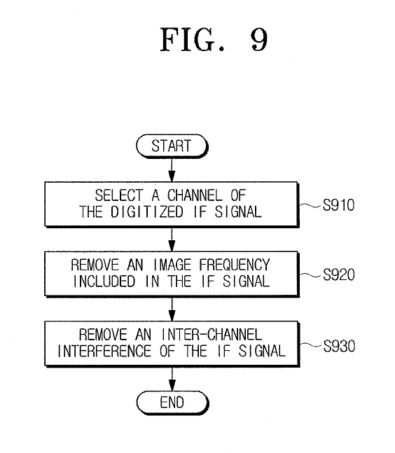

FIG. 9 is a flowchart illustrating a process of processing a digital signal of signal passing SD-ADC.

Referring to FIG. 9, in operation S910, the digitized IF signal output from the SD-ADC is selected. In operation S920, an image frequency included in the IF signal is removed, and in operation S930, an inter-channel interference of the IF signal is removed to correctly select a channel.

Accordingly, an improved silicon tuner is provided.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to an exemplary of the present general inventive concept, power consumption is reduced by using an SD-ADC whereby a mobile device is applicable, and power consumption is also reduced when a conventional electric device such as a TV and/or a set top box is used.

Also, a layout size of an image corresponding to a desired channel is reduced, and an image rejection and an adjacent inter-channel interference are also reduced satisfactorily.

An inside AGC is driven in a part in which an AGC signal is received from a digital chip or channel chip, and is processed such that a simple gain control is provided. More specifically, a detector may detects signals of input and output ports, respectively, of an IF signal processor to drive an inside automatic gain control (AGC). The detector may then output a control signal to adjust AGC gain of an RF controller and an IF automatic gain controller according to a size of a detected signal level.

Because digital signal and an analog signal are selectively output, both ATSC (which is a digital television system used in America) and NTSC (which is an analog television system used in America) are available. As a result, user convenience is improved.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A silicon tuner, comprising:
an RF signal processor to process a radio frequency (RF) signal input from an antenna;
a mixer to convert the RF signal into an intermediate frequency (IF) signal;
a sigma delta-analog digital converter (SD-ADC) to convert the IF signal into a digital signal; and
an IF signal processor to process the converted IF signal.

2. The silicon tuner as claimed in claim 1, further comprising:
a detector to detect signals of input and output ports of the IF signal processor.

3. The silicon tuner as claimed in claim 2, further comprising:
an IF automatic gain controller to control intensity of a signal input to the SD-ADC according to the signal detected by the detector.

4. The silicon tuner as claimed in claim 2, wherein the RF signal processor comprises:
an RF controller to control intensity of the RF signal input from the antenna according to the signal detected by the detector; and
an RF bandpass filter to filter the controlled RF signal.

5. The silicon tuner as claimed in claim 1, wherein the IF signal processor comprises:
a channel selector to select a channel of the IF signal;
an image remover to remove an image frequency component of the IF signal; and
a channel filter to remove an inter-channel interference of the IF signal.

6. The silicon tuner as claimed in claim 1, further comprising:
a digital converter to increase a frequency of the converted IF signal which passes through the IF signal processor;
an A/D converter to convert the IF signal into an analog signal; and
an analog output unit to output the analog IF signal which passes through the A/D converter.

7. The silicon tuner as claimed in claim 1, further comprising:
a digital output unit to output the digitized IF signal passing the IF signal processor.

8. The silicon tuner as claimed in claim 1, further comprising:
a filter to remove harmonic a component of the IF signal which passes through the mixer and a signal component of an adjacent channel.

9. A method of processing a signal, comprising:
processing an RF signal input through an antenna;
converting the RF signal into an IF signal;
digitizing the IF signal by using SD-ADC; and
processing the digitized IF signal.

10. The method of processing a signal as claimed in claim 9, further comprising:
detecting an intensity of the IF signal passing the SD-ADC and intensity of the digitized IF signal.

11. The method of processing a signal as claimed in claim 10, further comprising:
controlling an intensity of an analog IF signal input to the SD-ADC by using the intensity of the IF signal passing the detected SD-ADC and the intensity of the digitized IF signal.

12. The method of processing a signal as claimed in claim 10, wherein the processing of the RF signal input through the antenna comprises:
controlling an intensity of an RF signal by using the intensity of the IF signal passing the detected SD-ADC and the intensity of the digitized IF signal; and
filtering the controlled RF signal in an RF band.

13. The method of processing a signal as claimed in claim 9, wherein processing of the digitized IF signal comprises:
selecting a channel of the digitized IF signal;
removing an image frequency included in the digitized IF signal; and
removing an inter-channel interference of the digitized IF signal.

14. The method of processing a signal as claimed in claim 10, further comprising:
increasing a frequency of the digitized IF signal;
converting the increased digitized IF signal into an analog signal; and
outputting the analog IF signal.

15. The method of processing a signal as claimed in claim 9, further comprising;
outputting the digitized IF signal.

16. The method of processing a signal as claimed in claim 9, further comprising:
removing a harmonic component of the IF signal and a signal component of an adjacent channel.

17. A computer readable recording medium having embodied thereon a computer program to execute a method, wherein the method comprises:
processing an RF signal input through an antenna;
converting the RF signal into an IF signal;
digitizing the IF signal by using SD-ADC; and
processing the digitized IF signal.

18. A silicon tuner, comprising:
a sigma delta-analog digital converter (SD-ADC) to convert an IF signal into a digital signal; and
an IF signal processor to process the converted IF signal, such that the converted IF signal is output if the converted IF signal is digitized or the converted IF signal is converted to an analog signal and then output.

19. The silicon tuner of claim 18, further comprising:
a digital converter to increase a frequency of the converted IF signal which passes through the IF signal processor;
an A/D converter to convert the IF signal into an analog signal; and
an analog output unit to output the analog IF signal which passes through the A/D converter.

20. The silicon tuner of 18, further comprising:
a digital output unit to output the digitized IF signal passing the IF signal processor.

21. A method of processing a signal, comprising:
converting an IF signal into a digital signal; and
processing the converted IF signal,
wherein the converted IF signal is output if the converted IF signal is digitized or the converted IF signal is converted to an analog signal and then output.

22. A computer readable recording medium having embodied thereon a computer program to execute a method, wherein the method comprises:
converting an IF signal into a digital signal; and
processing the converted IF signal,
wherein the converted IF signal is output if the converted IF signal is digitized or the converted IF signal is converted to an analog signal and then output.
